(19) United States
(12) Patent Application Publication
(10) Pub. No.: US 2007/0230793 A1
(43) Pub. Date: Oct. 4, 2007

(54) Method and apparatus for pattern matching processing

(75) Inventor: Takahiro Fuchigami, Yokosuka-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/396,535

(22) Filed: Apr. 3, 2006

(51) Int. Cl. G06K 9/46

(52) U.S. Cl. 382/190

(57) ABSTRACT

Pattern data constituted by a plurality of elements is extracted from input image data. Template data constituted by a plurality of elements and weight data constituted by a plurality of elements and associated with the template data are read from a memory. A calculation is performed on each element using the pattern data, the template data, and the weight data to calculate a similarity value representing the degree of matching between the pattern data and the template data using the sum of calculation results obtained from the calculations on each element. The similarity value is compared with a predetermined threshold to obtain a determination output indicating whether there is a match between the pattern data and the template data or not.

### BACKGROUND OF THE INVENTION

1. Field

The present invention relates to a method and apparatus for pattern matching processing, and it is advantageous, for example, when used for an OCR (optical character reader).

2. Description of the Related Art

An OCR (optical character reader) recognizes a character through a pattern matching process. In a pattern matching process, a value indicating the degree of pattern matching is calculated from pattern data constituted by a plurality of elements (plural items of pixel data) extracted from an input image and template data constituted by a plurality of elements (pixel data) for pattern determination stored in advance in storage means. The calculated value is compared with a predetermined threshold to obtain a determination output indicating whether there is a desired pattern corresponding to the input image or not.

As the value indicating the degree of pattern matching, similarity S as expressed by Expression 1 shown below is frequently used.

$$S = \frac{{\sum }_{i } {\sum }_{j} P ( i , j ) ⨯ Q ( i , j ) }{\sqrt{{\sum }_{i} {\sum }_{j} {P ( i , j )}^{2} } ⨯ \sqrt{{\sum }_{i} {\sum }_{j} {Q ( i , j )}^{2}}} \qquad ( 1 )$$

where P(i, j) represents pattern data obtained by extracting a partial area of an input image, and Q(i, j) represents template data for pattern determination. “i” and “j” represent non-negative integers.

One document disclosing a technique for a pattern matching process is Japanese Patent No. 3572203. According to the document, a common template is created by combining characteristic parts of plural items of template data. Matching calculations are carried out to obtain similarity between the common template and pattern data constituted by a plurality of elements extracted from an input image. This method of processing allows the efficiency of a pattern matching process to be improved.

When a pattern matching process is performed, even if an input pattern (a character or the like) is slightly different from a pattern to be detected in the thickness of lines, the size of points, and the like, the input pattern must be determined to be the same pattern as the pattern which should be detected. For example, let us assume that there is a plurality of characters which are identical except that they are different in the thickness of lines. Then, those characters must be determined as identical characters. When a plurality of templates to be used for the characters having different lines are prepared as template data for comparison with input pattern data in such a case, a greater memory capacity will be required, and matching calculations will take a long time.

### BRIEF SUMMARY OF THE INVENTION

Under the circumstance, it is an object of an embodiment of the invention to provide a method and apparatus for pattern matching which have high flexibility and diversified recognition capabilities in recognizing input pattern data.

In the above-mentioned embodiment, pattern data constituted by a plurality of elements is extracted from input image data; template data constituted by a plurality of elements stored in advance in storage means is read; weight data constituted by a plurality of elements stored in advance in storage means in association with the template data is read; a calculation is performed on each element using the pattern data, the template data, and the weight data; a similarity value representing the degree of matching between the pattern data and the template data is calculated using the sum of calculation results obtained by the calculation on each element; and the similarity value is compared with a predetermined threshold to obtain a determination output indicating whether there is a match between the pattern data and the template data or not.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of a configuration of a pattern matching processing apparatus presented for explaining an embodiment of the invention.

FIG. 2 is a flow chart shown to explain an example of operations of the apparatus in FIG. 1.

FIG. 3 is an illustration shown to explain a predetermined size of pattern data.

FIG. 4 is an illustration shown to explain examples of template data and weight data for a comparison with the pattern data.

FIG. 5 is a flow chart shown to explain another example of operations of the apparatus in FIG. 1.

FIG. 6 is an illustration shown to explain examples of template data and weight data and examples of patterns which can be detected.

FIG. 7 is an illustration shown to explain examples of template data and weight data and other examples of patterns which can be detected.

FIG. 8 is a diagram showing an example of a configuration of a pattern matching processing apparatus presented for explaining another embodiment of the invention.

### DETAILED DESCRIPTION OF THE INVENTION

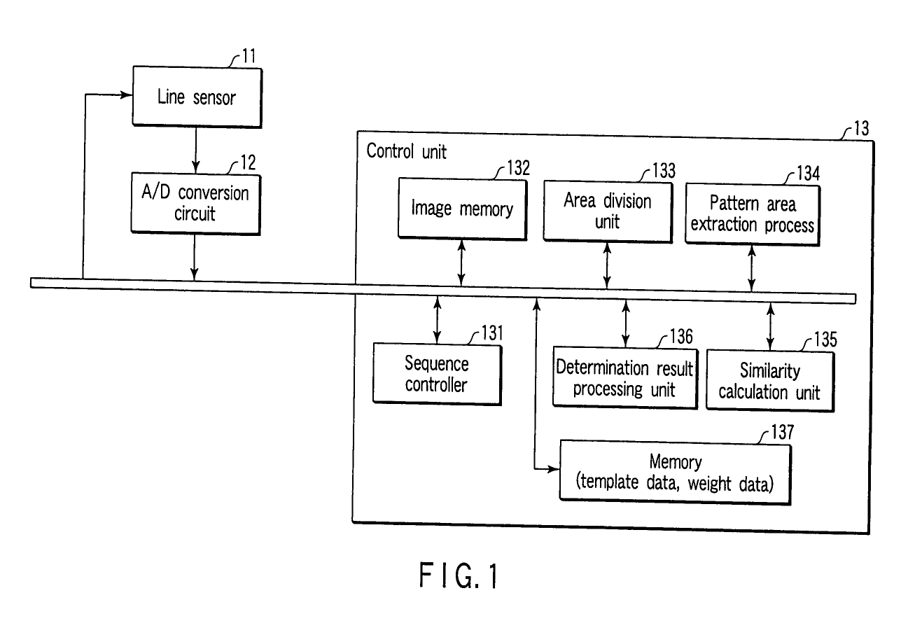

An embodiment of the invention will now be described with reference to the drawings. FIG. 1 shows an apparatus according to an embodiment of the invention.

11 represents a line sensor which utilizes, for example, a charge coupled device (CCD). A signal read by the line sensor 11 is converted at an analog-to-digital conversion circuit 12 into image data which is then fetched into a control unit 13. The control unit 13 temporarily fetches the image data into an image memory 132. The image data fetched into the image memory 132 is binarized at an area division unit 133.

Pattern data having a predetermined size (the same size as that of template data) is extracted from the binarized data at a pattern area extraction process unit 134. The pattern data is represented by P(i, j).

The above-described extraction process may be performed on the entire binary image such that an area having a predetermined size is incremented one pixel at a time. Alternatively, in order to allow subsequent processes to be performed efficiently, the size of an outline in which the binary pattern exits may be determined, and only an area having a predetermined size encompassing the outline size may be extracted.

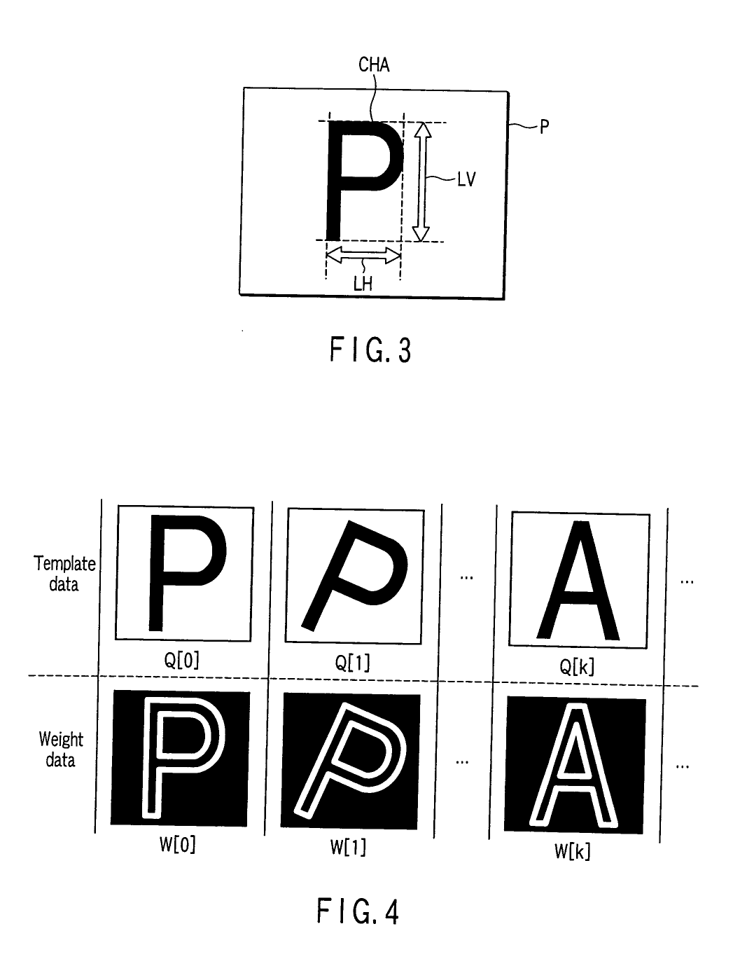

Referring to the method of determining an outline size, as shown in FIG. 3, a vertical length (LV) of an array of continuous binary pattern data CHA is determined, and a horizontal length (LH) of the array of continuous binary data CHA is determined. When the vertical and horizontal lengths satisfy a predetermined length, an area P which has the outline size or the predetermined size as described above may be extracted.

The pattern data having the predetermined size extracted as described above is compared with template data at a similarity calculation unit 135 to calculate similarity between them. A plurality of template data is prepared. As will be described later, weight data is prepared to allow the process of determining similarity to template data to be performed with some allowance or flexibility when similarity is calculated.

The result of similarity determination made by the similarity calculation unit 135 is input to a determination result processing unit 136. When the result of similarity determination exceeds a threshold, the character represented by the pattern data is finally determined. A sequence controller 131 controls the sequence in which each of the above-described blocks executes the data processing. 137 represents a memory in which the template data and weight data are stored.

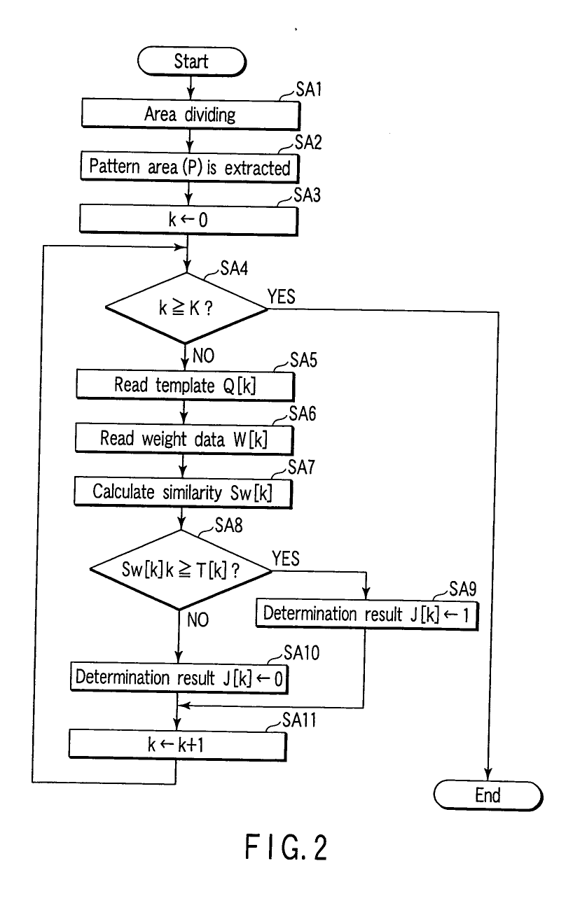

FIG. 2 shows the above-described operations in the control unit 13 in the form of a flow chart. Image data is binarized at step SA1.

A process of extracting a pattern area from the binary data is performed. Specifically, pattern data having a predetermined size (which is the same as that of a template data) is extracted.

At the next step or step SA3, an initial value is given to a template No. k, and it is determined at step SA4 whether k has reached a maximum value K. When k has reached the maximum value K at step SA4, the pattern recognition process terminates.

When k has not reached the maximum value K, template data Q[k] (i, j) associated with k is read from storage means or the memory 137 (step SA5). Weight data W[k] (i, j) associated with the template data is read from the memory 137 (step SA6). The template data and weight data may be completely different types of patterns or identical patterns at different inclinations, and such patterns may be selectively used depending on purposes.

FIG. 4 shows exemplary template data Q[0], Q[1], . . . , Q[k] and weight data W[0], W[1], . . . , W[k]. The template data Q[0] represents an example of a character which is arranged in a normal attitude, and Q[1] represents an example of a character which is arranged at an inclination. Referring to the weight data, a lighter weight is applied to a white part surrounding a character. For example, a weight of 2 is applied to a black part, and a weight of 1 is applied to a white part.

Weighted similarity Sw[k] is calculated from the pattern data P, template data Q[k], and weight data W[k] (step SA7). Referring to the method of calculating similarity, for example, Expression 2 is used.

$$Sw [ k ] = \frac{{\{ {\sum }_{i} {\sum }_{j} P ( i , j ) ⨯ Q [ k ] ( i , j ) ⨯ W [ k ] ( i , j ) \}}^{2} }{\{ {\sum }_{i} {\sum }_{j} {P ( i , j )}^{2} ⨯ W [ k ] ( i , j ) \} ⨯ \{ {\sum }_{i} {\sum }_{j} Q [ k ] {( i , j )}^{2} ⨯ W [ k ] ( i , j ) \} } \qquad ( 2 )$$

Next, it is determined whether the similarity exceeds a predetermined value T[k] (step SA8). If the similarity does not exceed the predetermined value T[k], a determination result J[k] of 0 is asserted (step SA10), and similarity between the next template and the pattern data P is calculated (step SA11). If the similarity exceeds the predetermined value T[k], a determination result J[k] of 1 is asserted (step SA9).

When Expression 2 given above is used, multiplications and divisions must be carried out, which requires a tremendously large circuit scale when implemented as hardware.

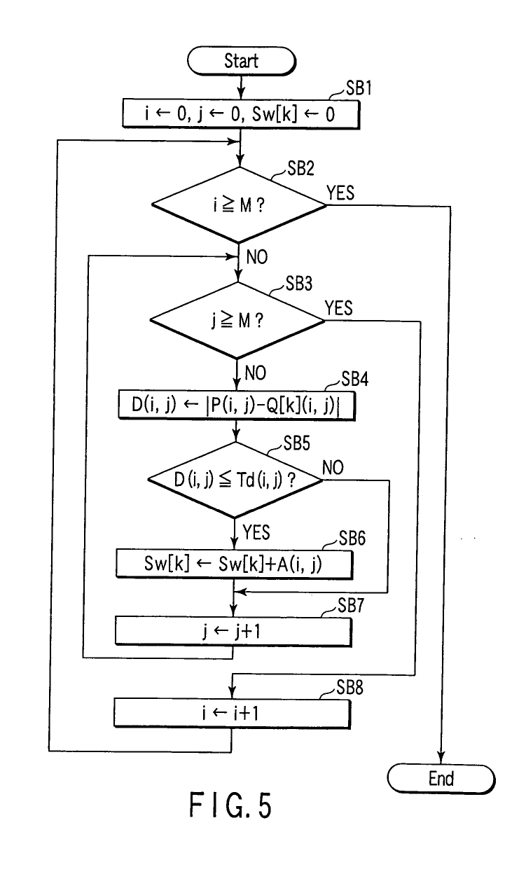

In order to suppress such an increase in circuit scale, a simple method as represented by the flow chart shown in FIG. 5 may alternatively be used. Specifically, the absolute value of a difference D(i, j) between the pattern data P(i, j) and the template data Q[k] (i, j) is obtained for each element (steps SB1, SB2, SB3, and SB4).

Based on a comparison between the difference D(i, j) and a predetermined threshold Td(i, j), the sum of the selected values (the difference D(i, j)) may be used as similarity Sw[k].

That is, when a difference D(i, j) is equal to or smaller than the predetermined threshold Td(i, j), there is similarity. When the difference exceeds the predetermined threshold Td(i, j), there is no similarity. When there is similarity, weight data A(i, j) is added to obtain similarity Sw[k]. All pixels in the predetermined size are compared with the pixel of the template data by varying j and i to obtain similarity Sw[k].

The description is continued by referring to FIG. 2 again. The calculated degree of similarity Sw[k] is compared with the threshold T[k] associated with the template data (SA8). A determination result J[k] of 1 is asserted if the value Sw[k] is equal to or greater than T[k] (SA9), and a determination result J[k] of 0 is asserted when the value Sw[k] is smaller than T[k] (SA10). The above-described processes at SA5 to SA10 are executed for all of the template data stored.

As described above, a plurality of similar patterns having different outline sizes can be detected at one matching process by combining the template data and the weight data to apply a smaller weight to unstable parts near edges of the patterns to be detected (parts which are uncertain in that they may become either of “1” and “0” as a result of binarization and which leave the patterns unchanged in global views thereof regardless of the result of binarization).

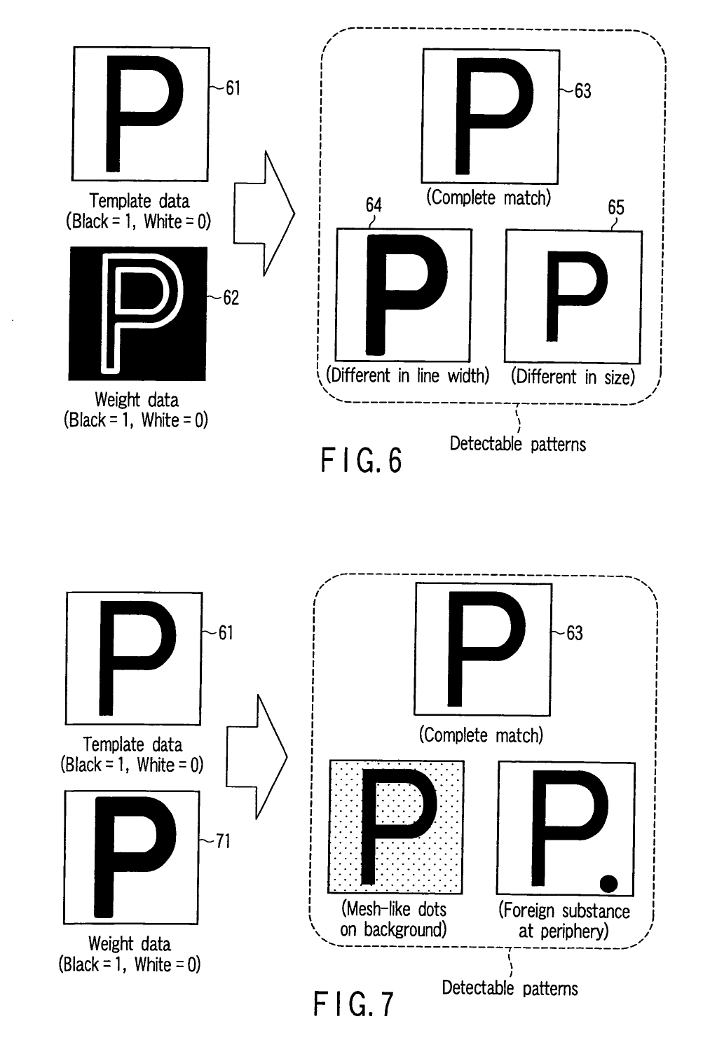

Specifically, when template data 61 and weight data 62 associated with the same are prepared as shown in FIG. 6, patterns as shown on the right side of FIG. 6 can be detected. That is, a pattern 63 which completely matches the template can obviously be detected, and a pattern 64 having a different line width and a pattern 65 having a different size can be also detected.

As will be apparent from the above, in the example shown in FIG. 6, the weight data associated with the template data has a difference in the value of weight between an element thereof corresponding to the edge of the body of the pattern and an element thereof other than the same.

On the contrary, weight data 71 which applies a greater weight to the neighborhood of the edge of a pattern to be detected (and a part of the pattern to be detected) may be prepared as shown in FIG. 7. When such weight data 71 is used, patterns as shown on the right side of FIG. 7 can be detected. Specifically, a pattern 63 which completely matches the template can obviously be detected, and the desired pattern can be accurately detected even when there are noises such as mesh-like dots or a foreign substance on the background.

As will be apparent from the above, in the example shown in FIG. 7 the weight data associated with the template data has a difference in weight between the body of the pattern and an element located around the same.

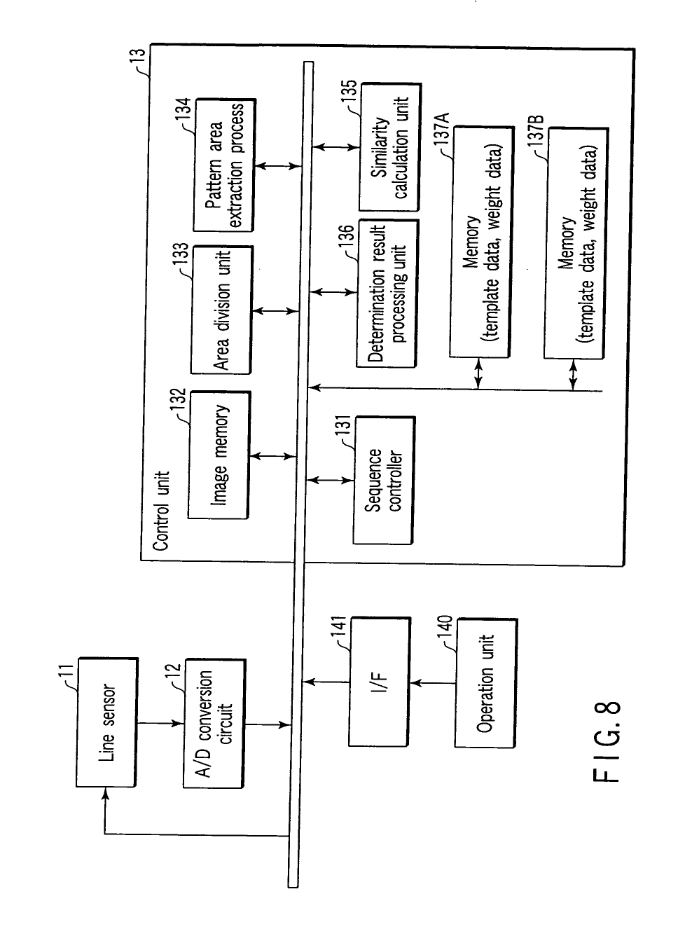

The invention is not limited to the above-described embodiment. FIG. 8 shows another embodiment. The embodiment will be described with parts identical to those in FIG. 1 indicated by like reference numerals. A memory 137A having data as shown in FIG. 6 and a memory 137B having data as shown in FIG. 7 are prepared, and they may be switched by an operation at an operation unit 140. Weight data as shown in FIG. 7 is suitable when there are many noises on the background, and weight data as shown in FIG. 6 is preferred when there are many characters having different line widths. Further, those items of weight data may be used in combination.

The invention is not limited to the exact modes of the above-described embodiments and may be embodied by modifying the constituent elements without departing from the gist of the same when implemented. Various inventions may be conceived by appropriately combining a plurality of the constituent elements disclosed in the above-described embodiments. For example, some constituent elements may be deleted from among the entire constituent elements described in the embodiments. Further, constituent elements belonging to the different elements may be combined as occasion demands.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of pattern matching processing comprising the steps of:
extracting pattern data constituted by a plurality of elements from input image data;
reading template data constituted by a plurality of elements stored in advance in storage means;
reading weight data constituted by a plurality of elements stored in advance in storage means in association with said template data;
performing a calculation on each of said elements using said pattern data, said template data, and said weight data;
calculating a similarity value representing the degree of matching between the pattern data and the template data using the sum of calculation results obtained by the calculation on each element; and
comparing the similarity value with a predetermined threshold to obtain an output of determination on whether there is a match between the pattern data and the template data or not.

2. A method of pattern matching processing according to claim 1, wherein the calculation on each of said elements includes:
a calculation performed between said pattern data, said template data, and the weight data;
a calculation using said pattern data and the elements of the weight data; and
a calculation using said template data and the elements of the weight data.

3. A method of pattern matching processing according to claim 1, wherein the weight data associated with said template data has a difference in the value of weight between an element corresponding to the edge of the body of the pattern and an element other than the same.

4. A method of pattern matching processing according to claim 1, wherein the weight data associated with said template data has a difference in the value of weight between an element located at the body of the pattern and around the pattern and an element other than the same.

5. A method of pattern matching processing comprising the steps of:
extracting pattern data constituted by a plurality of elements from input image data;
reading template data constituted by a plurality of elements for pattern determination stored in advance in storage means;
reading weight data constituted by a plurality of elements stored in advance in storage means in association with said template data;
performing a calculation on each of said elements using said pattern data and said template data;
comparing the result of calculation on each element with a predetermined first threshold to obtain a calculation result equal to or smaller than the threshold;
adding said calculation result equal to or smaller than the threshold with weight data associated therewith to calculate a similarity value representing the degree of pattern matching; and
comparing said similarity value with a second threshold to obtain a determination output on whether there is a match between said pattern data and said template data or not.

6. A method of pattern matching processing according to claim 5, wherein the weight data associated with said template data has a difference in the value of weight between an element corresponding to the edge of the body of the pattern and an element other than the same.

7. A method of pattern matching processing according to claim 5, wherein the weight data associated with said template data has a difference in the value of weight between an element located at the body of the pattern and around the pattern and an element other than the same.

8. A pattern matching processing apparatus comprising:
a pattern data extraction unit for extracting pattern data constituted by a plurality of elements from input image data;
a memory in which template data constituted by a plurality of elements and weight data constituted by a plurality of elements and associated with said template data are stored in advance;
a similarity calculation unit for performing a calculation on each element using said template data constituted by a plurality of elements, said weight data constituted by a plurality of elements, and said pattern data to calculate a similarity value representing the degree of matching between the pattern data and the template data using the sum of calculation results on each element; and
a determination process unit for comparing said similarity value with a predetermined threshold to obtain a determination output indicating whether there is a match between said pattern data and said template data.

9. A pattern matching processing apparatus according to claim 8, wherein the memory holds weight data having a difference in the value of weight between an element corresponding to the edge of the body of the pattern and an element other than the same as said weight data.

10. A pattern matching processing apparatus according to claim 8, wherein the memory holds weight data having a difference in the value of weight between an element located at the body of the pattern and around the pattern and an element other than the same as said weight data.

11. A pattern matching processing apparatus according to claim 8, wherein the memory holds weight data having a difference in the value of weight between an element corresponding to an edge of the body of the pattern and an element other than the same as a first type of weight data and weight data having a difference in the value of weight between an element located at the body of the pattern and around the pattern and an element other than the same as a second type of weight data, the apparatus further comprising an operation unit for performing switching to select either type of weight data.
